(19) United States
(12) Patent Application Publication
(10) Pub. No.: US 2010/0007315 A1
(43) Pub. Date: Jan. 14, 2010

(54) HIGH-EFFICIENCY POWER SUPPLY DEVICE AND CONTROL METHOD THEREOF

(75) Inventor: Chien Kuei Hsu, Taoyuan City (TW)

Correspondence Address: APEX JURIS, PLLC, 12733 LAKE CITY WAY NORTHEAST, SEATTLE, WA, 98125, US

(73) Assignee: ENERMAX TECHNOLOGY CORPORATION, Taoyuan City (TW)

(21) Appl. No.: 12/169,812

(22) Filed: Jul. 9, 2008

(51) Int. Cl. G05F 3/00

(52) U.S. Cl. 323/233

(57) ABSTRACT

The present invention discloses a high-efficiency power supply device and its control method. The power supply device includes a power conversion circuit and a load balance detection circuit. The power conversion circuit is connected to at least one set of switch module through an electric circuit, a resistor connected in parallel with the switch module, and a power output load terminal for driving a load. The load balance detection circuit is connected to the power conversion circuit and the switch module, such that the load balance detection circuit can detect whether or not a load driven by one or more sets of power output load terminals is balanced. If the driven load is not balanced, then the one or more sets of resistor will be in a closed circuit status to achieve a load balance.

### FIELD OF THE INVENTION

The present invention relates to a technology of improving the efficiency and reducing the loss of a power supply device, and more particularly to a power supply device that improves the efficiency of the load balance of a high-efficiency power adapter and its control method by a detection circuit and a switch module to achieve a power saving effect.

### BACKGROUND OF THE INVENTION

As present existing computers usually come with a power supply device (Power supply/PSU) for supplying a 110V or 220V AC power through an external cable, and a power conversion circuit (such as a forward conversion circuit or a twin crystal forward conversion circuit) converts the 110V or 220V AC power into a plurality of 12V, 5V or 3.3V DC voltage sources required by hardware equipments such as a motherboard, a hard disk, and an optical disk drive. However, in a practical application of the power adapter, there is a power output balance issue. For instance, if an output voltage (+3.3V) bears a higher load, the voltage (+5V or +12V) also requires a specific load for balancing the load of the voltage (+3.3V). If the voltage (+5V or +12V) has an insufficient load, the output voltage (+3.3V) will be reduced, and an under voltage protection device for the output voltage in the power supply device will be started. As a result, the power supply device will be turned off. The aforementioned phenomenon occurs frequently when the power supply device is actually connected to the motherboard. Since the design of motherboards produced by different manufacturers varies, some motherboards have an unbalanced load of the output voltage of the power supply device when the system boots instantly, and thus the system cannot boot. In general, if a system cannot boot, users will attempt to reboot the system and waste electric power, or send the system for repair and delay their job or increase the maintenance and repair costs.

Even if the prior art has one or more sets of output load structures for bearing a minimum load required by the load balance as shown in FIGS. 1A and 1B, and a resistor 112 (which is a bleeder resistor) is installed and coupled between a power conversion circuit 111 and a power output load terminal 113 for improving and stabilizing a voltage change to prevent insufficient output voltage or an automatic system shutdown, the operation of the resistor 112 will also cause a power loss, which is one of the main factors of causing a low efficiency of the power supply device. In FIG. 1C, the multi-output load structure includes a mag-amp postregulator circuit 114 installed between the power conversion circuit 111 and the resistor 112, and the resistor 112 is connected to a power output load terminal 115 of a mag-amp postregulator for converting and outputting a +3.3V voltage to drive related computer components. Similarly, the resistor 112 also causes a power loss.

As the energy crisis becomes increasingly serious, we can save tens of billions of kWh power each year if the operation efficiency of the power supply device can be enhanced for the huge number of computer uses (U.S. well-known Forrester Research estimates that the number of personal computers used in the whole world will be up to one billion by the end of 2008), and thus finding a way of improving the operation efficiency of the power supply device demands immediate attentions, innovative breakthroughs and feasible solutions.

In view of the foregoing shortcomings of the prior art having a poor operation efficiency of power conversion and the system compatibility issue, the inventor of the present invention based on years of experience to conduct extensive researches and experiments, and finally developed a high-efficiency load power adapter and its control method with a smooth and efficient power-saving balanced load power adapter and its control method to overcome the shortcomings of the prior art and fulfill a long desired need.

### SUMMARY OF THE INVENTION

Therefore, the primary objective of the present invention is to provide a high-efficiency power supply device and its control method that adds a load balance detection circuit and a switch module for detecting the status of one or more sets of power output load terminal. If the load is not balanced, then the switch module is connected to one or more sets of resistor to show a closed circuit status to achieve a load balance. If the load is balanced, then the switch module is connected to one or more sets of resistor to show an open circuit status, so as to reduce the power consumption.

A further objective of the present invention is to provide a high-efficiency power supply device and its control method, such that the power adapter adds a load balance detection circuit for detecting a status of the output voltage, current or waveform of a power output load terminal, such that a balance load device is started before the protection of the power supply device is operated to achieve a load balance and improve the compatible of the power supply device and the motherboard to avoid system down and enhance the operation efficiency of the power supply device, so as to achieve the power saving effect and improve the economic efficiency.

To achieve the foregoing objective, the present invention provides a power supply device comprising a power conversion circuit, and a load balance detection circuit. The power conversion circuit further includes at least one set of switch module, a resistor connected in series with the switch module through an electric circuit, and a power output load terminal for driving a load. The resistor is connected in parallel with a load driven by the power output load terminal. The load balance detection circuit us coupled to the power conversion circuit and the switch module, so that the load balance detection circuit can detect whether or not a load driven by one or more sets of power output load terminals is balanced. If the driven load is not balanced, then the switch module will be connected to one or more sets of resistor to show a closed circuit status, so as to achieve a load balance. If the load is balanced, then the switch module will be connected to one or more sets of resistors to show an open circuit status, so as to reduce power consumption.

To make it easy for our examiner to understand the technical characteristics and performance of the present invention, preferred embodiments together with related drawings are used for the detailed description of the present invention as follows.

### BRIEF DESCRIPTION OF THE DRAWINGS

FIGS. 1A, 1B and 1C are schematic views of operations of a conventional power conversion circuit;

FIG. 2 is a schematic view of a first preferred embodiment of the present invention;

FIG. 3 is a schematic view of a second preferred embodiment of the present invention;

FIG. 4 is a schematic view of a third preferred embodiment of the present invention;

FIG. 5 is a flow chart of operations in accordance with the present invention.

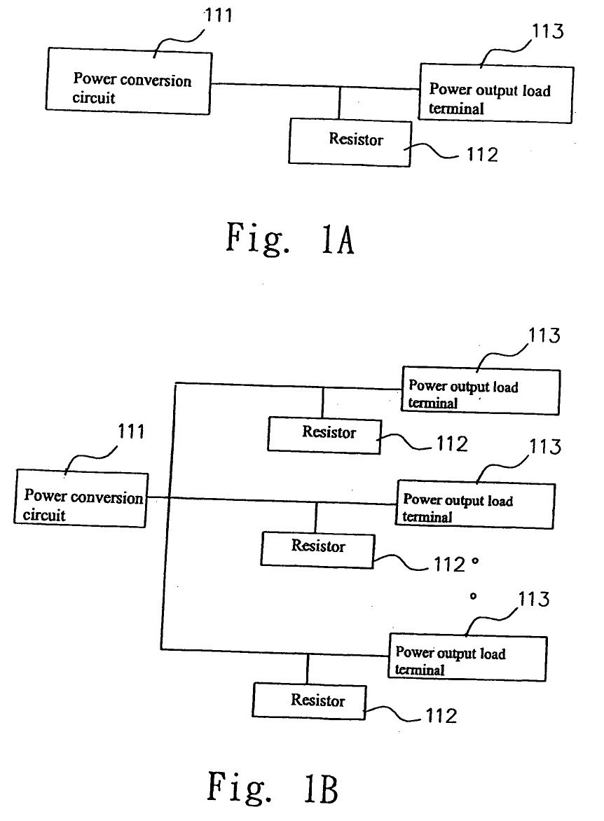

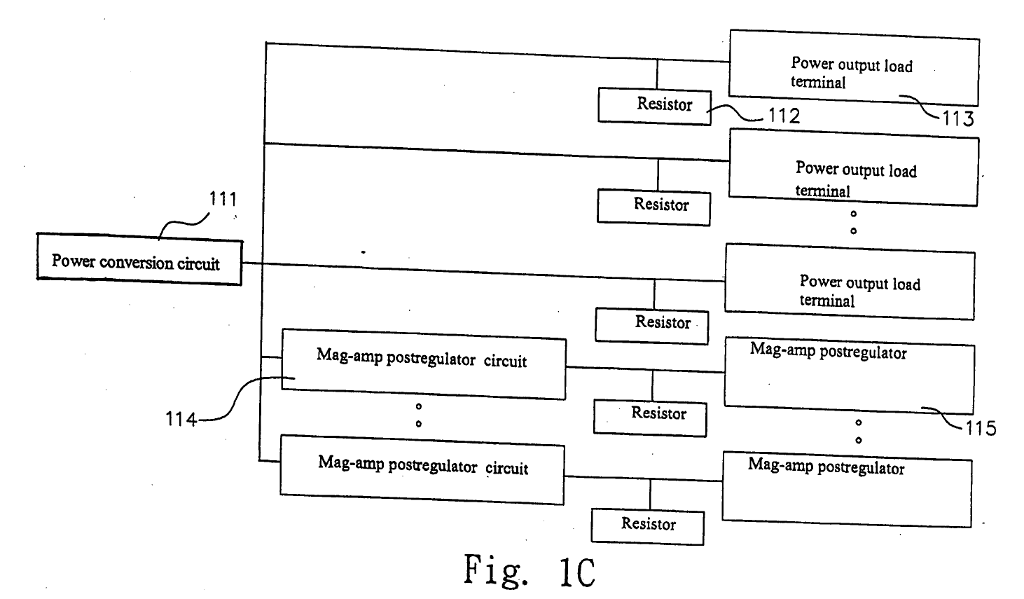

### DESCRIPTION OF THE PREFERRED EMBODIMENT

The above and other objects, features and advantages of the present invention will become apparent from the following detailed description taken with the accompanying drawing.

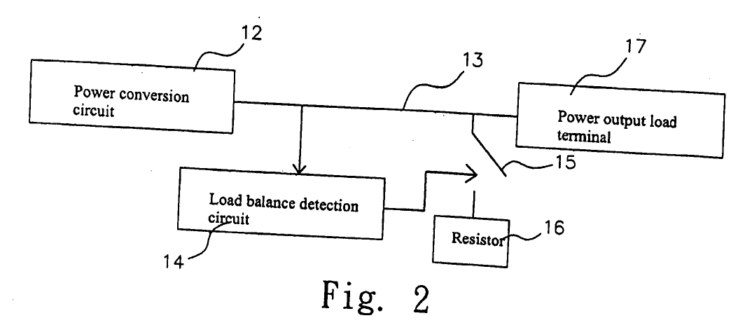

With reference to FIG. 2 for a high-efficiency power supply device in accordance with a first preferred embodiment of the present invention, the high-efficiency power supply device comprises a power conversion circuit 12, an electric circuit 13, and a load balance detection circuit 14. The electric circuit 13 of the power conversion circuit 12 is coupled to a set of switch module 15, and a resistor 16 and a power output load terminal 17 (connected to a load) serially connected to the switch module 15. The load balance detection circuit 14 is connected to the power conversion circuit 12 and the switch module 15. The resistor 16 and a load connected to the power output load terminal 17 are connected in parallel with each other, such that the power output load terminal 17 can provide sufficient voltage and regulate its voltage change to start the load and prevent a system down. The load balance detection circuit 14 is provided for detecting whether or not a load (such as voltage, current or waveform) connected to one or more sets of power output load terminals 17 is balanced. If the drive load is not balanced, then the switch module 15 is connected to one or more sets of resistor 16 to show a closed circuit status, so as to achieve a load balance (boosting the voltage) connected to the power output load terminal 17. After the load balance connected to the power output load terminal 17 is operated, one or more sets of resistor 16 connected to the switch module 15 are in an open circuit status to reduce the power consumption.

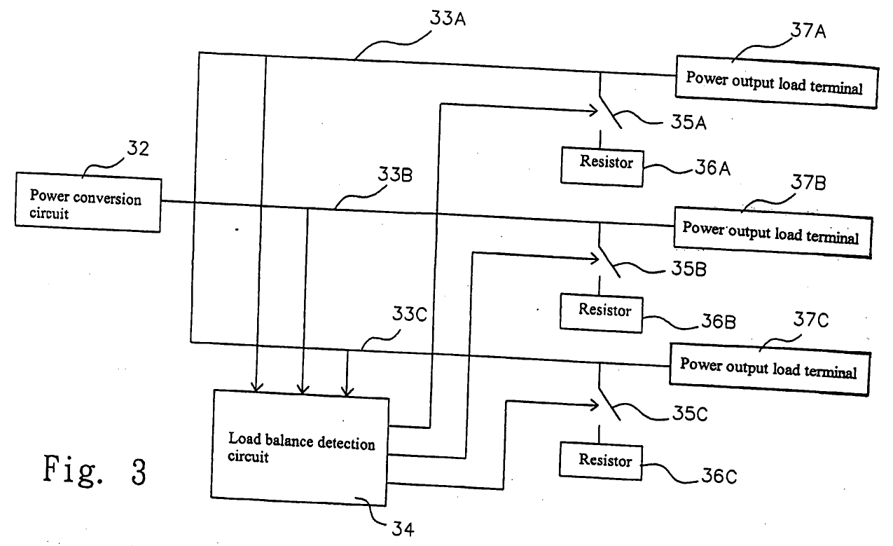

With reference to FIG. 3 for a second preferred embodiment of the present invention, this embodiment adopts a plurality of sets of power conversion circuits (which includes three sets) and comprises a power conversion circuit 32, three electric circuits 33A, 33B, 33C, and a load balance detection circuit 34. The electric circuits 33A, 33B, 33C of the power conversion circuit 32 are connected to a set of switch modules 35A, 35B, 35C, and the switch modules 35A, 35B, 35C are connected in series with a plurality of resistors 36A, 36B, 36C and a plurality of power output load terminals 37A, 37B, 37C (connected to loads respectively). The load balance detection circuit 34 is connected to the power conversion circuit 32 and the switch modules 35A, 35B, 35C. The resistors 36A, 36B, 36C are connected in parallel with the loads driven by the power output load terminals 37A, 37B, 37C, such that the power output load terminals 37A, 37B, 37C have sufficient voltage and stabilize the voltage change to start the load and avoid a system down. The load balance detection circuit 34 is provided for detecting whether or not a load such as a status of a voltage, a current and a waveform driven by one or more sets of power output load terminals 37A, 37B, 37C is balanced. If the driven load is not balanced, then the switch modules 35A, 35B, 35C will be connected to the resistors 36A, 36B, 36C to show the status of one or more sets of closed circuit status to achieve a load balance (boosting the voltage) connected to the power output load terminals 37A, 37B, 37C. After the load balance connected to the power output load terminals 37A, 37B, 37C is operated, the resistors 36A, 36B, 36C connected to the switch modules 35A, 35B, 35C are in an open circuit status to reduce power consumption.

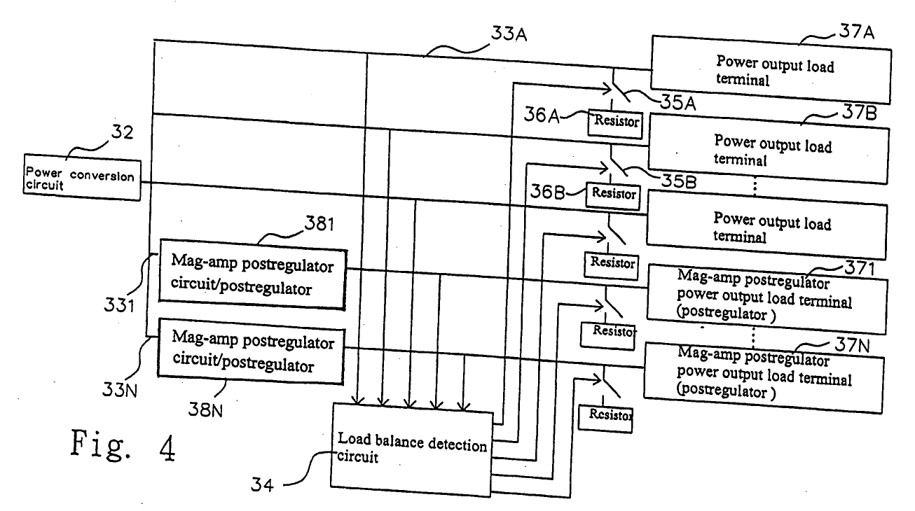

With reference to FIG. 4 for a third preferred embodiment of the present invention, the difference between this preferred embodiment and the second preferred embodiment resides on that the power conversion circuit 32 is connected to a plurality of sets of electric circuits 331-33N, and the specific electric circuits (331-33N) are connected to a plurality of mag-amp postregulator circuits/postregulators 381-38N, and the electric circuits 331-33N is connected to a mag-amp postregulator power output load terminal (postregulator) 371-37N through the load balance detection circuit 34 and each set of switch module (35) and resistor (36).

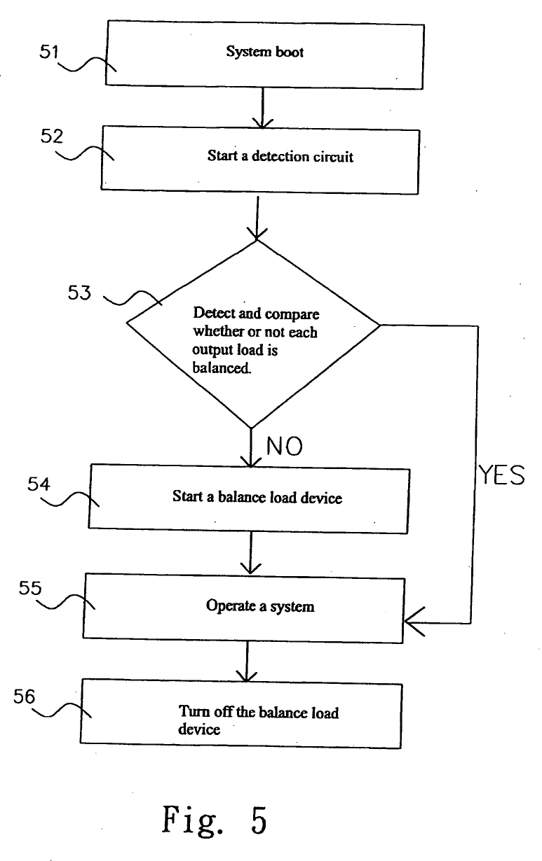

With reference to FIG. 5 for a flow chart of the operation of a high-efficiency power supply device and its control method in accordance with the present invention, the method comprises the steps of:
(1) booting a system 51 by turning the power on;
(2) starting a detection of a circuit 52;
(3) detecting and comparing whether or not each set of output load is balanced 53, and continuing the procedure if the load is not balanced;
(4) starting a balance load device 54, such that the balance load device drives each set of output load to a load balance;
(5) operating the system 55; and
(6) turning off a balance load device 56.

After the system boots, each load is no longer situated at an unbalanced condition anymore during the instant boot. Now, the balance load device will turn off the switch module (to show an open status) to reduce the power consumption of the resistor, so that the power supply device can achieve a higher efficiency of power saving.

The detection circuit is the load balance detection circuit 14 as described in the first preferred embodiment, and the balance load device is the switch module 15 and the resistor 16 described in the first preferred embodiment. In the aforementioned step (3), if each set of output load is balanced, then the system operation as described in Step (5) will be performed as shown in FIG. 5.

Therefore, the installation of the detection circuit can perform a load test (including the tests for the booting stage and the system operating stage) anytime. If the load is not balanced, then the balance load device will be turned on to achieve a load balance, so as to improve the compatibility between the power supply device and the motherboard, prevent the system from being unable to boot, enhance the operating efficiency of the power supply device, achieve the power saving effect and a high economic efficiency.

In summation of the description above, the present invention improves over the prior art and complies with the patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A high-efficiency power supply device, comprising:
a power conversion circuit, coupled to at least one set of switch module and resistor, and said power conversion circuit being coupled to a load balance detection circuit, and said load balance detection circuit being coupled to said switch module, said switch module being coupled to said resistor, and said load balance detection circuit detecting an output status of said set of circuit to selectively turn on and off said switch module.

2. The high-efficiency power supply device of claim 1, wherein said power conversion circuit is coupled to a plurality of sets of said switch modules and said resistor.

3. The high-efficiency power supply device according to claim 1, wherein said output status is a status of a voltage, a current or a waveform.

4. The high-efficiency power supply device according to claim 2, wherein the power conversion circuit is coupled to a mag-amp postregulator circuit.

5. The high-efficiency power supply device according to claim 4, wherein the power conversion circuit is coupled to a power output load terminal of the mag-amp postregulator.

6. A control method of a high-efficiency power supply device, comprising:
(1) starting a load balance detection circuit;
(2) detecting and comparing whether or not each output load is balanced, and continuing said detection and comparison if said load is not balanced;
(3) starting a balance load device, and the balance load device including a switch module and a resistor; and
(4) operating a system.

7. The control method of a high-efficiency power supply device according to claim 6, further comprising a step of continuing a procedure of turning off said balance load device to achieve an open circuit status.

8. The control method of a high-efficiency power supply device according to claim 6, wherein further comprising a procedure of performing a system boot before said step (1).

9. The control method of a high-efficiency power supply device according to claim 6, further comprising a stage of a system operation status before said step (1).
